(19) United States
(12) Patent Application Publication
(10) Pub. No.: US 2024/0225346 A1
(43) Pub. Date: Jul. 11, 2024

(54) DRINKS PREPARATION MACHINE WITH A PLACEMENT ELEMENT FOR POSITIONING DIFFERENT VESSELS FOR RECEIVING THE DRINK

(71) Applicant: Tchibo GmbH, Hamburg (DE)

(72) Inventors: Alexander Erdwiens, Darmstadt (DE); Micha Daniels, Sulzbach (DE)

(21) Appl. No.: 18/558,397

(22) PCT Filed: May 5, 2022
(86) PCT No.: PCT/EP2022/062205

§ 371 Date: Nov. 1, 2023

(30) Foreign Application Priority Data
May 6, 2021 (EP) 21172377.0

(51) Int. Cl. A47J 31/44

(52) U.S. Cl. CPC A47J 31/4482; A47J 31/4428

(57) ABSTRACT

A drinks preparation machine with a placement element for positioning different vessels in the drinks preparation machine for receiving the prepared drink. The placement element can be arranged relative to the outlet of the drinks preparation machine in a first alignment and in a second alignment different from the first alignment. A vessel for receiving the prepared drink can be placed on the placement element during the drinks preparation in the first alignment and in the second alignment.

### BACKGROUND OF THE INVENTION

### Field of the Invention

The invention relates to a drinks preparation machine with a placement element for positioning different vessels in the drinks preparation machine for receiving the prepared drink, which is to say during a preparation process, as well as to the placement element itself. With regard to the drinks preparation machine, in particular it is a drinks preparation machine for preparing a drink from a portion capsule, in particular a coffee capsule machine.

### Description of Related Art

The demands upon drinks preparation machines are continuously increasing. This on the one hand is due to the fact that it is the desire of the user to be able to prepare drinks which are individualised, for example with regard to the drinks quantity, taste (in particular strength), preparation or and/or share of different constituents (for example coffee and milk). At the same time, the operation and maintenance of the drinks preparation machine is to be kept as simple and intuitive as possible, the space requirement of the drinks preparation machine is to remain as small as possible and the optical appearance is to be that of high quality.

In other words, concerning modern drinks preparation machines, in particular modern drinks preparation machines for non-commercial operation, amongst other things there is the object of increasing the variety of drinks and preparations without herein increasing the operation, the maintenance and the space requirement or worsening the optical appearance.

Closely related to this object is the question of how one can permit the use of different vessels for receiving a drink which is prepared by the drinks preparation machines, wherein these vessels differ in particular in their size, in particular their height.

For this, the state of the art basically provides two solutions. According to a first solution, the drinks preparation machine includes a cup platform which can be pulled out of a base body (housing, base unit) of the drinks preparation machine. A corresponding drinks preparation machine is disclosed for example in WO 2017/067788 A1.

According to the second solution, the drinks preparation machine includes a type of fold-out table which is arranged on a wall of the base body of the drinks preparation machine.

These solutions for placement elements for different vessels are unsatisfactory since they include for example hinges and/or guides and are thus complex and therefore expensive in manufacture, as well as prone to error and damage on use. Furthermore, these solutions are also unsatisfactory concerning the maintenance, since they increase the cleaning effort. This is essentially dependent on the number of parts of the placement element which are to be cleaned and their accessibility as well as possible contamination and their accessibility on or in the base body of the drinks preparation machine. Finally, at least the first mentioned solution according to the state of the art (cup platform which can be pulled out of the base body) increases the space requirement of the drinks preparation machine, since the cup platform usually is voluminous.

### SUMMARY OF THE INVENTION

It is the object of the invention to provide a drinks preparation machine which includes a placement element, with which different vessels for receiving the prepared drink can be positioned as optimal as possible during the preparation process and which overcomes the disadvantages of drinks preparation machines with placement elements according to the state of the art, for example of the aforementioned cup platforms which can be pulled out or of fold-out tables. Herein, the different vessels in particular differ from one another in their size, in particular in their height. As to which of the different vessels is positioned as optimally as possible to the drinks preparation machine during the preparation process by way of using the placement element depends on a selection by the user. The selection can be dependent, for example, on the prepared drink, which is to say the vessel is matched to the prepared drink, or can be the result of other considerations, for example a preference for a certain vessel.

In particular, it is an object of the invention to provide a drinks preparation machine which includes a placement element with which different vessels for receiving the prepared drink are positionable as optimally as possible during the preparation process and which with regard to the manufacturing effort, reliability, in particular the proneness to error and damage, and/or maintenance, in particular cleaning effort, is improved compared to placement elements according to the state of the art.

It is further an object of the invention to provide the placement element itself.

A drinks preparation machine according to the invention which includes a placement element according to the invention further includes an outlet for the delivery of a prepared drink and a receiving region for receiving a vessel for receiving the prepared drink.

The outlet is usually arranged at an outlet hood, for example at its lower side.

The receiving region is delimited to the top by the outlet and/or the outlet hood.

The drinks preparation machine, in particular the placement element and a region of the drinks preparation machine which includes the receiving region, is such that the placement element can be arranged relative to the outlet in a first alignment and in a second alignment, wherein the second alignment is different from the first alignment.

The drinks preparation machine, in particular the placement element and a region of the drinks preparation machine which includes the receiving region, is designed such that a vessel for receiving the prepared drink can be placed on the placement elements during the drinks preparation in the first alignment of the placement element as well as in the second alignment of the placement element. Herein, the position of a first vessel or of a first vessel group within the drinks preparation machine, in particular relative to the outlet, is optimised when the placement element is situated in the first alignment, and the position of a second vessel or of a second vessel group is optimised within the drinks preparation machine, in particular relative to the outlet, when the placement element is situated in the second alignment. The first vessel or the first vessel group in particular differs from the second vessel or from the second vessel group in the vessel height.

With a view to the placement element, its constitution as well as its arrangement in the drinks preparation machine in the first alignment as well as the second alignment is such that a vessel for receiving the drink which is prepared by the drinks preparation machine can be placed on the placement element during the drinks preparation. Herein, in a first alignment, the placement element optimises the position of a first vessel, and in a second alignment the placement element optimises the position of a second vessel, wherein the first and the second vessel in particular differ in the vessel height.

The constitution of the placement element in particular relates to the presence of a horizontally arranged surface in the first as well as in the second alignment of the placement element, on which surface a vessel for receiving the prepared drink can be placed during the drinks preparation.

In a preferred embodiment, the horizontal surface, in case of the first alignment of the placement element, and the horizontal surface, in case of the second alignment of the placement element, is a surface or are surfaces of the same region of the placement element. This means that according to a first variant of this embodiment, it is one and the same surface of the placement element on which a vessel can be placed given the first and second alignment, and that the mentioned region according to a second variant of this embodiment can includes two surfaces, on which a vessel can be placed given a corresponding alignment of the placement element.

In particular, the second variant is of interest with regard to the objects which are to be achieved by the invention. For example, the region can be designed in a plate-like manner, wherein a first flat side of the plate-like region forms the surface, on which a vessel can be placed in case of the first alignment of the placement element and wherein the flat side which lies opposite the first flat side forms the surface, on which a vessel can be placed in case of the second alignment of the placement element.

Independently of whether the horizontally arranged surface in case of the first alignment and the horizontally arranged surface in case of the second alignment are realised according to the first or second variant, the region of the placement element can be a first region of the placement element and the placement element can include a second region. Herein, the first region is arranged horizontally in the first as well as in the second alignment, wherein a vessel for receiving the prepared drink can be placed on the first region in the first as well as in the second alignment during the drinks preparation.

Furthermore, concerning this embodiment, the second region is at an angle to the first region in the first as well as in the second alignment of the placement element.

In an embodiment, the angle is a non-changeable angle. This means that the second region runs at the same angle relative to the first region in the first alignment as well as in the second alignment. In particular, this angle can be 90°.

Independently as to whether one or more of the features of embodiments of the placement element which have been mentioned previously or hereinafter are realised, in an embodiment the placement element can be realised as an L-shaped element.

In particular, an element is L-shaped if the element in a cross section, in particular in every cross section along a straight axis essentially has the shape of the capital letter L or if the cross section of the element or the cross sections along the straight axis are characterised by an L-shaped part.

In other words, an element is L-shaped in particular if it is formed essentially of a first, usually plate-like region and of a second, usually plate-like region, wherein the two regions run at an angle. Herein, the angle is about 90°, in particular 90°.

“Essentially the shape of a capital letter L”, “characterised by an L-shaped part” and “essentially formed of a first, usually plate-like region and of a second, usually plate-like region” means that further structures or elements can be present, which however are small in comparison to those elements which make up the L-shaped shape, in particular in comparison to the first region and to the second region. An opening, through which the fluid can run, or a holding region as is described hereinafter, are examples of such further structures or elements.

As can be derived from that stated above, an L-shaped placement element includes a first, usually plate-like region and a second, usually plate-like region, wherein the first and the second region are connected along a connection axis, in particular exactly one usually straight connection axis. The first region has an extension of the first region along a first axis which is perpendicular to the connection axis and the second region has an extension of the second region along a second axis which is perpendicular to the connection axis. In other words, the first region in the radial direction to the connection axis has an extension of the first region and the second region in the radial direction to the connection axis has an extension of the second region.

“L-shaped” does not mean that the extension of the first region must be larger or smaller than the extension of the second region. In an embodiment of the placement element, the extension of the first region is equal to the extension of the second region.

Independently of whether one or more of the features mentioned previously and hereinafter of embodiments of the placement element are realised, the placement element can include one or more of the following features:
The placement element is of one piece. This means that no part of the placement element can be removed from the placement element in a non-destructive way and manner.
   In an embodiment, not only is the placement element of one piece but it also includes no moving parts. This means that no part of the placement element can move relative to another part of the placement element in a non-destructive manner.
The placement element is formed from a plate-like starting body, for example cut out or moulded. This includes embodiments, concerning which only one part which is defining for the shape and the function of the placement element is formed from a plate-like starting body. A part of the placement element is defining for the shape and function in particular when a vessel for receiving the prepared drink can be placed on a region of the plate-like part during the drinks preparation and a further plate-like region of the plate-like part makes a contribution to the positioning of the placement element during the drinks preparation in the drinks preparation machine. This contribution can be for example the fixing of a distance to another element of the drinks preparation machine and/or a supporting function.
   In an embodiment, the placement element is formed from the plate-like starting body in such a manner that the placement element forms no volume for receiving a solid object or a liquid. In other words, the placement element defines no volume, in which a solid object or a fluid, for example liquid which exits out of the outlet of the drinks preparation machine can be collected.
   In particular, the placement element forms no volume which is delimited to the sides.
   In particular, a body is plate-like if its extension in a plane is significantly larger than its extension in a direction perpendicular to this plane.

It is self evident that the placement element independently of its specific realisation, in the first as well as well as second alignment has a stability which is adequate for supporting a commercially available vessel which is filled with the prepared drink.

As already mentioned, the constitution of the placement element as well as its arrangement in the drinks preparation machine in the first alignment as well as in the second alignment is such that a vessel for receiving the drink which is prepared by the drinks preparation machine can be placed on the placement element during the drinks preparation, wherein the placement element in the first alignment optimises the position of a first vessel and the placement element in the second alignment optimises the position of a second vessel.

With a view to the arrangement of the placement element in the drinks preparation machine and independently of the specific constitution of the placement element, the first alignment in particular differs from the second alignment in that the placement element is arranged in a manner rotated about a horizontal axis.

If for example the placement element is realised as an L-shaped element, the first alignment can correspond to an L in the alignment which is usual for use, which means with a vertical part and a horizontal part which engages at the lower end of the vertical part, whereas the second alignment corresponds to an L which is upside down, which is to say is rotated about a horizontal axis by 180°.

Independently of the exact constitution of the placement element, the placement element supplementarily or alternatively can be arranged in a loose and exposed manner in the drinks preparation machine in the first as well as in the second alignment.

In particular, the placement element is loosely arranged in the drinks preparation machine if it can be completely removed from the drinks preparation machine by a user by way of a simple linear movement, in particular a simple linear movement to the top, without manipulating the drinks preparation machine or parts thereof and without disengaging movement or the like. Somewhat exaggerated, one can also say that the placement element is loosely arranged in the drinks preparation machine if it falls out of this as soon as the drinks preparation machine is tilted somewhat to the front or to the side.

In particular, the placement element is exposed if is not inserted into the housing of the drinks preparation machine.

Means which prevent an undesired displacement of the placement element in the operationally ready drinks preparation machine can be provided in the drinks preparation machine. These means can be such that an undesired displacement of the placement element is only prevented in its first or second alignment. The means however can also be such that an undesired displacement of the placement element is prevented in its first as well as second alignment.

Usually, which is to say independently of the specific realisation of the drinks preparation machine and of the placement element, the placement element in the first and well as in the second arrangement is arranged in a region between the outlet and a drip tray of the drinks preparation machine.

In an embodiment, the placement element includes one or more holding regions which can engage into a structure of a drip tray in such a manner that a movement of the placement element along a horizontal direction and/or a rotation of the placement element about a horizontal axis is prevented.

The holding region or holding regions engage into the structure of the drip tray in particular along a vertical direction.

The holding region or the holding regions and the structure into which this or these engage, in particular can form a positive fit in the horizontal direction.

The placement element can include a first holding region for the first alignment and a second holding region for the second alignment. In particular, this is the case if the first alignment differs from the second alignment in the placement element being is arranged rotated about a horizontal axis.

As mentioned, the placement element via its constitution and alignment in the drinks preparation machine serves for optimising the position of different vessels for receiving the prepared drink during the preparation process. First and foremost, this is effected by way of the placement element defining a different distance between the outlet and the surface of the placement element, on which surface a vessel can be placed, depending on the alignment.

In an embodiment, the placement element in the first alignment as well as in the second alignment delimits the receiving region in the direction which is opposite to the outlet. In other words, the placement element delimits the receiving region to the bottom in the first as well as second alignment. Herein, the placement element defines a first extension of the receiving region in a direction which lies opposite the outlet (usually, this means to the bottom) when the placement element is arranged in the first alignment, and a second extension of the receiving region in the direction which lies opposite to the outlet (usually, this means to the bottom) when the placement element is arranged in the second alignment, wherein the first extension differs from the second extension. In other words, the extension of the receiving region in the vertical direction depends on the alignment of the placement element.

The first extension can differ from the second extension in particular by a length of the second region, wherein the length of the second region is the extension of the second region along a straight line which runs from a contact line between the first and the second region and perpendicularly to this contact line along the second region.

The invention also relates to the placement element itself, which is to say a placement element for the positioning of vessels of different sizes, in particular of a different vessel height, in a drinks preparation machine for receiving the prepared drink.

Concerning the drinks preparation machine, in particular it is one of the previously described drinks preparation machines in any one of the previously described embodiments.

In a preferred embodiment, the placement element has a shape which in a first alignment includes a first horizontal surface which is suitable for depositing a vessel, and which in a second alignment includes a second horizontal surface which is suitable for depositing a vessel. Herein, the second alignment is an alignment which is rotated about a horizontal axis in comparison to the first alignment.

The rotation angle about the horizontal axis in order to bring the placement element from the first alignment into the second alignment in particular can be 180°.

The placement element can include one, more or all of the features which are mentioned in the context of the placement element of the drinks preparation machine. In particular, the placement element can include one or more of the following features:
The first horizontal surface can be different from the second horizontal surface.
   The first horizontal surface and the second horizontal surface can be surfaces of the same region of the placement element. In a multitude of embodiments, the first and second horizontal surface are different horizontal surfaces which however are formed by the same region of the placement element.
   The first horizontal surface and the second horizontal surface in particular can be the previously described horizontal surface given the first alignment of the placement element and the previously described horizontal surface given the second alignment of the placement element and the placement element can be realised in each embodiment which has been described hitherto in this context.
The placement element can be formed of a plate-like starting body, in particular in a way and manner which have been described previously.
   In particular the placement element can be formed from the plate-like starting body and additionally include the previously described first and second regions in one of the described embodiments.
   In particular, the placement element can be formed from the plate-like starting body such that it forms no volume in the previously described context for receiving a solid object or a liquid.
The placement element can be realised as an L-shaped element in the previously described context.
   If the placement element is realised as an L-shaped element, usually the parts of the L-shaped element which run at an angle, usually at roughly 90° form the previously mentioned first and second region.
The placement element can be of one piece, in particular of one piece in one of the previously described manners.
   In an embodiment, the placement element which is formed from a plate-like starting body is of one piece.
Disregarding an optionally present holding region in one of the previously described manners, the placement element can include no elements whatsoever which connect the placement element to the drinks preparation machine or can be led through this.
   The placement element can be configured for a loose and exposed arrangement in the drinks preparation machine.

In particular, the placement element can be formed from a plate-like starting body, be of one piece and L-shaped. Herein, “formed from a plate-like starting body”, “of one piece” and “L-shaped” in particular are to be understood in the previously mentioned context.

### BRIEF DESCRIPTION OF THE DRAWINGS

Embodiment examples of the invention are hereinafter described by way of the figures. In the figures, the same reference numerals denote the same or analogous elements. There are shown in:

FIG. 1 An exemplary embodiment of the drinks preparation machine with an exemplary placement element in a first alignment;

FIG. 2 An exploded representation of the drinks preparation machine according to FIG. 1; and

FIG. 3 The drinks preparation machine according to FIG. 1 with the placement element in a second alignment.

### DETAILED DESCRIPTION OF THE INVENTION

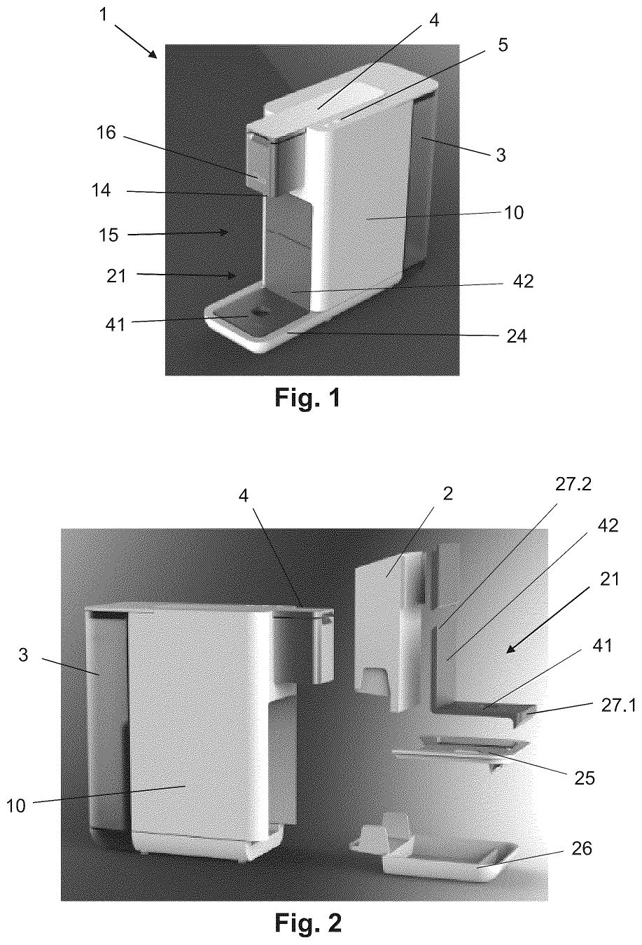

FIG. 1 shows an exemplary embodiment of a drinks preparation machine 1 according to the invention which in particular includes a placement element 21 according to the invention, in an exemplary embodiment.

The shown drinks preparation machine 1 is a coffee capsule machine which apart from the placement element 21 includes the following elements:
An operating lever 4 which can be brought from a closed position into an open position, wherein the operating lever 4 in the closed position closes a capsule insert opening for bringing a capsule into the drinks preparation machine and wherein the capsule insert opening lies open when the operating lever 4 assumes the open position.
Operating elements 5, via which the drink which is prepared by the drinks preparation machine 1 can be individualised.
A water tank 3, from which water is taken during the preparation process, in order to feed it to the brewing chamber of the drinks preparation machine 1.
An outlet hood 16 which includes an outlet 14, from which the prepared drink exits out of the drinks preparation machine 1.
A drip tray 24 which in the shown embodiment includes a receiving element 26 and a cover element 25. The cover element 25 closes the receiving element 26 to the top.
A capture container 2 (only visible in FIG. 2), into which spent portion capsules are ejected.

The placement element 21 serves for positioning a vessel which is selected by a user from a plurality (this means at least two) vessels, relative to the outlet 14 in an optimal manner during the preparation process for receiving the prepared drink or at least in a more optimal manner in comparison to a placement element which leads to a fixed distance between the vessel base and the outlet 14.

Accordingly, the placement element 21 together with the outlet 14 or the outlet hood 16 defines a receiving region 15 of the drinks preparation machine 1 in which a vessel is brought and which by way of the placement element 21, according to the present invention in particular by way of the alignment of the placement element 21 within the drinks preparation machine 1, can be optimised or at least improved for a certain vessel or a certain group of vessels.

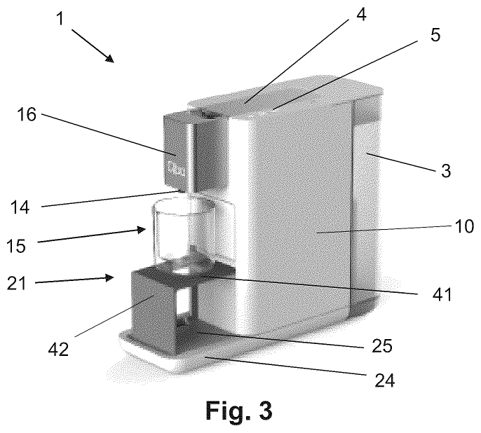

In the embodiment which is shown in FIG. 1, the placement element 21 is arranged in the drinks preparation machine 1 in a first alignment which is particularly suited to a first vessel. FIG. 3 shows the same drinks preparation machine 1 with the same placement element 21 which is arranged in the drinks preparation machine 1 in a second alignment which is particularly suited to a second vessel.

The shown placement element 21 is an L-shaped placement element which is shaped as one piece from a plate-like starting body. Consequently, this in an operationally ready state of the drinks preparation machine includes a first horizontally aligned region 41 and a second vertically aligned region 42. The first region 41 forms the placement surface for a vessel in the first alignment which is shown in FIG. 1 as well as in the second alignment which is shown in FIG. 3.

The first alignment differs from the second alignment in that the placement element 21 in the second alignment is upside down in comparison to the first alignment, which means has been rotated by 180° about a horizontal axis which runs parallel to the front of the drinks preparation machine 1, wherein the second regions 42 which as was hitherto the case is aligned vertically serves as a support for the first region 41 which is now displaced towards the outlet 14 and is aligned horizontally as was hitherto the case.

That vertically running side of the drinks preparation machine 1 which on operation faces the user and from which for example the outlet hood 16 and the drip tray 24 project is denoted as the front of the coffee machine.

Disregarding the placement element 21, all previously mentioned elements of the drinks preparation machine 1 are arranged completely or partly within a basis unit 10 (housing, basis body) of the drinks preparation machine 1, for example due to them belonging to the inner workings of the drinks preparation machine 1 (for example brewing chamber) and therefore being arranged within the basis unit 10, since they are advantageously not projecting beyond the basis unit 10 and are therefore arranged completely within or at least flush with the basis unit (for example water tank 3 or capture container 2) or since they need to assume a certain position relative to the basis body 10 and therefore partly arranged, for example inserted, within the basis unit 10 (for example drip tray 24).

In contrast to the mentioned elements of the drinks preparation machine 1, in the operationally ready state of the shown drinks preparation machine 1 and independently of whether the placement element 21 is arranged in the first alignment which is particularly suitable for the first vessel (FIG. 1) or in the second alignment which is particularly suitable for the second vessel (FIG. 3), the placement element 21 is arranged in an exposed or loosely lying manner in, or expressed better, on the drinks preparation machine 1.

FIG. 2 shows the drinks preparation machine according to FIG. 1 in an exploded representation. Therein, the L-shaped placement element 21 according to the shown exemplary embodiment and which is formed as one piece from a plate-like starting body can be recognised particularly well.

Furthermore, a first holding region 27.1 and a second holding region 27.2 of the placement element 21 are visible in FIG. 2. These are realised as deviations of the placement element 21 from the L-shape and are dimensioned such that they can engage into a corresponding opening in the drip tray 24. By way of this, a slipping-away of the otherwise loose placement element 21 which bears on the drinks preparation machine 1 in an exposed manner can be prevented given a loading by way of a filled vessel.

As mentioned, FIG. 3 shows the drinks preparation machine 1 according to FIG. 1, concerning which the placement element 21 is arranged in the second alignment. That which is been sated with reference to FIG. 1 is referred to.

1. A drinks preparation machine, comprising:
an outlet for the delivery of a prepared drink,
a receiving region for receiving a vessel for receiving the prepared drink,
a placement element comprising a first region and a second region,
wherein the placement element can be arranged relative to the outlet in a first alignment and in a second alignment which is different from the first alignment, wherein a vessel for receiving the prepared drink can be placed on the placement element during the drinks preparation in the first alignment as well as in the second alignment, wherein the placement element is an L-shaped element.

2. The drinks preparation machine according to claim 1, wherein the first region is arranged horizontally in the first as well as in the second alignment, wherein a vessel for receiving the prepared drink can be placed on the first region in the first as well as in the second alignment during the drinks preparation.

3. The drinks preparation machine according to claim 1, wherein in the second alignment, the second region extends in a vertical direction and supports the first region towards a base of the drinks preparation machine.

4. The drinks preparation machine according to claim 3, wherein in the second alignment, the second region engages into an opening of the drinks preparation machine, wherein the opening extends from an exposed horizontal surface in the vertical direction.

5. The drinks preparation machine according to claim 1, wherein the first alignment differs from the second alignment in that the placement element is arranged rotated about a horizontal axis.

6. The drinks preparation machine according to claim 1, wherein the placement element is arranged in the drinks preparation machine in a loose and exposed manner in the first as well as in the second alignment.

7. The drinks preparation machine according to claim 1, wherein the placement element in the first as well as in the second alignment is arranged in a region between the outlet and a drip tray, wherein a holding region of the placement element engages into a structure of the drip tray such that a movement of the placement element along a horizontal direction and/or a rotation of the placement element about a horizontal axis is prevented.

8. The drinks preparation machine according to claim 1, wherein the placement element is a single-piece element.

9. The drinks preparation machine according to claim 1, wherein the placement element is formed from a plate-like starting body.

10. The drinks preparation machine according to claim 9, wherein the placement element is formed from the plate-like starting body in such a manner that the placement element forms no volume for receiving a solid object or a liquid.

11. The drinks preparation machine according to claim 1, wherein the placement element in the first alignment as well as in the second alignment delimits the receiving region in a direction which lies opposite to the outlet, wherein the placement element defines a first extension of the receiving region in the direction which lies opposite the outlet when the placement element is arranged in the first alignment, wherein the placement element defines a second extension of the receiving region in the direction which lies opposite to the outlet when the placement element is arranged in the second alignment, and wherein the first extension differs from the second extension.

12. A placement element for positioning vessels of different sizes in a drinks preparation machine for receiving the prepared drink, wherein the placement element is L-shaped.

13. The placement element according to claim 12, wherein the placement element in a first alignment comprises a first horizontal surface for depositing a vessel and in a second alignment comprises a second horizontal surface for depositing a vessel, wherein the second alignment is an alignment which is rotated about a horizontal axis in comparison to the first alignment.

14. The placement element according to claim 12, wherein the placement element is of one piece.
